(19) United States
(12) Patent Application Publication
(10) Pub. No.: US 2010/0057579 A1
(43) Pub. Date: Mar. 4, 2010

(54) METHOD AND SYSTEM FOR MANAGING PURCHASE TRANSACTIONS BETWEEN A CUSTOMER AND A MERCHANT

(76) Inventor: Kuan Loong Jeremy Tan, Singapore (SG)

Correspondence Address: GREER, BURNS & CRAIN, 300 S WACKER DR, 25TH FLOOR, CHICAGO, IL, 60606, US

(21) Appl. No.: 12/440,847

(22) PCT Filed: Apr. 18, 2007
(86) PCT No.: PCT/SG2007/000103

§ 371 Date: Mar. 11, 2009

(30) Foreign Application Priority Data
Sep. 11, 2006 (SG) 200606265-7

(51) Int. Cl. G06Q 20/00; G06Q 40/00

(52) U.S. Cl. 705/17; 705/21; 705/41

(57) ABSTRACT

A method of storing change resulting from a customer/merchant cash purchase, includes providing the customer with a customer electronic purse on a portable storage device for storing credit and the merchant with a merchant electronic purse for storing credit, communicating with the storage device through an access device communicating with the portable storage device, electronically crediting a value representing the change in the customer electronic purse from the merchant electronic purse, and debiting the merchant's electronic purse to an amount equivalent to the change that is credited to the customer electronic purse, the change value credited to the customer electronic purse is redeemable for further purchases, the customer electronic purse is stored solely in the storage device and the merchant electronic purse is stored solely in the access device, facilitating immediate transfer of credit directly from the merchant electronic purse to the customer electronic purse via the access device.

### TECHNICAL FIELD

A method and system for managing purchase transactions between a customer and a merchant.

### BACKGROUND OF THE INVENTION

Due to increasing commodity prices, in some cases, the cost of producing coins and metal value of coins exceeds the face value of the coins.

Carrying and handling coins is also a burden for merchants and consumers since in large quantities, they become heavy and bulky.

There is a desire to alleviate coin usage. Also, to complete a purchase transaction, it may be desirable to eliminate the use of coins to return change back to the consumer.

### SUMMARY OF THE INVENTION

The present invention seeks to alleviate at least one of the problems described above in relation the prior art.

The present invention may involve several different broad forms. Embodiments of the invention may include one or any combination of the different broad forms herein described.

In a first broad form, the present invention provides a method of storing change resulting from a cash purchase between a customer and a merchant, the method including the step of electronically crediting a value representing the change in to a customer electronic purse, wherein the value of the change that is credited in to the customer electronic purse is able to be redeemed for further purchases.

Typically, the cash purchase may involve the customer paying the merchant an amount of cash that is greater than a purchase price of the purchase transaction.

Preferably, the merchant may also have an electronic purse for storing credit. Typically, whenever the customer's electronic purse is credited with the value of the change owing to it, an equivalent amount may be debited from the electronic purse of the relevant merchant.

The present invention may be implemented using a computerised system. Typically, the computerised system may include a back-end server communicatively connected to a plurality of merchant terminals that may be physically located at the premises of participating merchants. The merchant terminals may typically include a point-of-sale (POS) device (eg. an EFTPOS machine, electronic cash register or the like) to enable cash payment for goods or services from the merchant to be processed. The POS device may be interfaced with an access device adapted for reading and/or writing to at least one of:
(a) a chip-based card (ie a “smart card”); and
(b) a stored value card; and
(c) a radio frequency identification (RFID) card.

Typically, the access device may include a smart card reader and/or a secure access module (SAM)—that is, it may have a dedicated processing device adapted for authenticating a smart card and also for securing the merchant electronic purse. Also typically, the access device may be adapted for either contactless and/or contact-based interaction with the smart card.

The access device may be conveniently interfaced with the POS device using a USB-type connector, Firewire connector, or any suitable serial-type connector. Typically, the access device may be programmed to visually or audibly output instructions to the customer via a display screen or speaker which may conveniently guide the customer through the steps involved in having change credited to his electronic purse. For instance, the access device may initially prompt the customer to place his customer smart card in proximity to the access device in order for it to be read. Advantageously, the present invention may be integrated on top of an existing cash payment system without the need to entirely replace the existing cash payment infrastructure.

Typically, the back-end server may be adapted for, amongst other things, storing and processing both the customer and merchant electronic purses. Typically a mirror of the customer electronic purse may also be stored on the customer smart card.

The back-end server may also include a desktop PC or the like having a database. The back end server and merchant terminals may be communicatively connected via a WAN, the Internet or any other suitable and preferably secured networking infrastructure including the use of a Network Access Controller (NAC) through dial-up.

Preferably, the present invention includes the step of the customer obtaining a customer smart card which includes:
an embedded processor;
a memory device operatively connected to the embedded processor; and
a customer electronic purse stored in the memory device.

Typically, the customer electronic purse may be implemented by way of at least one of a file or a memory slot for storing information representing monetary value of the electronic purse.

Typically, the customer smart card may be dispensed by an Issuer such as a participating merchant, or, from a vending machine. The Issuer may be responsible for not only issuing the customer smart card, but may also be responsible for implementing a security protocol for the issued customer smart cards to prevent unauthorized tampering with the electronic purse stored in the smart card.

Typically, the customer smart card may be either customer-specific or “anonymous”. Where the customer smart card is customer-specific, the present invention includes a means of associating a specific customer identity with the customer smart card that is issued. For instance, this may involve the customer being required to register the smart card by submitting his personal details to the back-end server together with a unique identifier embedded in the issued customer smart card. This step may involve the merchant scanning the customer smart card with the access device for the unique identifier and then submitting this code together with the customer's personal details for processing by the back-end server. Upon processing this information, a unique customer electronic purse may be created in the database for the customer.

Where the customer smart card is “anonymous”, the customer smart card may be issued without any subsequent step of registering and/or recording an identity of a customer who may be intending to use the customer smart card. The customer may simply use the electronic purse embedded in the smart card as he pleases without needing to verify his identity. It would be appreciated that any monetary value stored in an electronic purse of an anonymous customer smart card may be used by an unauthorized party relatively easily as opposed to a customer-specific smart card where the identity of the user has to be verified.

Similarly, each participating merchant may also be required to have a merchant electronic purse initialised in the database of the back-end server. The access device may include a unique identifier embedded in it which may be transmitted to the back-end server to be associated with the merchant's electronic purse.

Typically the present invention may provide the step of enabling a customer to voluntarily credit his electronic purse at any time. This may be facilitated by having a “top-up” machine made available wherein the “top-up” machine may be communicatively connected to the back-end sever via the WAN. When adding credit to the customer smart card, the “top up” machine may be adapted to read the electronic purse contained in the customer smart card, process a credit card or cash payment from the customer, and then upon verification of payment, instruct the back-end server to credit an amount to the corresponding customer electronic purse with the amount of credit purchased by the customer.

Similarly, the merchant may be able to add credit to its merchant electronic purse by purchasing the credit directly using the merchant terminal. The merchant terminal may for instance be able to read the merchant's credit card details and effect payment in this manner, then instruct the back-end server to credit the appropriate merchant electronic purse in the back end server database accordingly. Systems such as GIRO and the like may also be made available to the merchant to ensure that the merchant's electronic purse contains sufficient credit to be of use when transferring change to customers.

Typically, in use, when a purchase transaction is made between the customer and the merchant, the transaction may be conducted conventionally via the POS terminal. The access device may be programmed to detect when the POS terminal is to provide change to the customer in response to the cash payment transaction. The access device may thereafter be programmed to prompt the customer to place its customer smart card in proximity to the access device to be authenticated.

The access device may authenticate the customer smart card by reading and verifying the electronic purse embedded in the on-chip processor. The access device may thereafter generate a transactional log which includes the following:
(a) information relating to the customer electronic purse to be credited;
(b) information relating to the merchant electronic purse to the debited; and
(c) an amount of change owing to the customer from the merchant.
wherein the transaction log may be transmitted to the back-end server in order to enable settlement in real-time.

Thereafter, the back-end server may effect settlement in real-time by crediting the appropriately identified customer electronic purse by the amount of change owed, and, by debiting an equivalent amount from the electronic purse of the identified merchant.

Typically, the access device may also credit the customer electronic purse stored in the customer smart card.

In certain embodiments of the present invention settlement may be effected on a delayed basis. This may be the case by virtue of certain limitations inherent in the computerised system used to implement the present invention, and/or, as a deliberate operational approach.

In respect to the former, settlement may need to be delayed in certain cases where not all merchant terminals may be communicably connected to the back-end server (eg. to reduce communication and transactional costs). Because the customer and merchant electronic purses stored in the back-end server may not be able to be adjusted by certain merchant terminals, adjustment of the customer electronic purse disposed on the customer smart card is delayed to avoid discrepancies arising between the back-end server and the customer smart card records.

In the later case, even if all merchant terminals are communicably connected to the back-end server, it may be inefficient to frequently settle each transaction in the back-end server particularly where only relatively trivial amounts of change are frequently involved. Instead, it may be more efficient to wait for a predetermined threshold condition to be detected before effecting settlement—that is, for instance, when a cumulative amount of change owing to the customer exceeds a predetermined threshold amount (eg. $2.00). Alternatively, the predetermined threshold condition may involve simply waiting for a predetermined time period to elapse before proceeding to effect settlement.

Typically, due to the possibility of discrepancies arising between the back-end and the customer smart card, the present invention includes the step of providing a counter on the customer smart card which is adapted for tracking any unsettled transfers of change between merchants and the customer. Typically, the counter may include a read/writable data file stored in the memory device of the smart card. The counter may include details of at least the following:
(a) information identifying a merchant which has not yet effected settlement;
(b) information detailing the amount of change that has not been settled by the merchant;
(c) information detailing a cumulative amount of change that may be owed to the customer by merchant(s);
(d) information detailing the balance of the customer's electronic purse.

Typically, in cases where the present invention may allow for delayed settlement to take place, at least some of the merchant terminals may be programmed to automatically read customer smart cards and detect whether any unsettled transactions are recorded by the counter whenever a customer smart card is presented. The access devices may further be programmed to effect settlement for any such detected unsettled transactions, if the predetermined threshold condition has been met (eg. if a cumulative amount of change exceeds a predetermined threshold amount). The merchant terminal may therefore transmit the appropriately formatted transaction log to the back-end server as described above, to settle the unsettled transactions. Thereafter, further steps which may effected includes:
(a) re-setting the counter of the smart card to indicate that unsettled transaction(s) have now been settled; and
(b) adjusting the mirror electronic purse contained on the customer smart card such that the back-end and customer smart card are consistent.

In yet further embodiments of the present invention, there may not be a back-end server at all. In this embodiment, the customer's electronic purse may be stored solely in the smart card itself, and the merchant's electronic purse may for instance be stored in the access device of the merchant terminal. In this arrangement, the access device of every merchant terminal may include an SAM in order to securely read/write to the customer smart card electronic purse.

Thus, when settlement takes place in this arrangement (either in real-time or on a delayed basis), the access device may directly credit the customer electronic purse of the customer smart card, and, may debit the merchant electronic purse stored in the access device.

Typically, at least some of the method steps of the present invention may be implemented by an administrator. Typically, the administrator may be include a person who manually performs the method step(s), or, may include a computerised system which may be programmed to perform the method step(s) automatically. Preferably, the administrator may include a person working in combination with a computerised system. Typically the computerised system includes the back-end server.

Advantageously, the present invention may provide the administrator at least one opportunity to generate a revenue stream. For instance the administrator may chare a fee for:
(a) purchasing customer smart cards and for hosting the customer's electronic purse;
(b) participating in the scheme and for hosting each merchant a fee for hosting its electronic purse;
(c) settling transactions on the back end server;
(d) making advertising space available on smart cards;
(e) managing FLOAT.

In a second broad form, the present invention provides a computerised system programmed to perform at least one of the method steps in accordance with the first broad form of the present invention.

In a third broad form, the present invention provides a computer readable medium for storing a computer program adapted for implementing the method steps in accordance with the first broad form of the present invention.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows a diagram of a computerised system which is used in accordance with the method steps of a first embodiment of the present invention;

FIG. 2 shows a flowchart broadly depicting the steps involved in performing the method in accordance with the first embodiment of the present invention;

FIG. 3 shows a conceptual diagram depicting how settlement is effected in real-time in accordance with the first embodiment of the present invention.

### DETAILED DESCRIPTION OF THE INVENTION

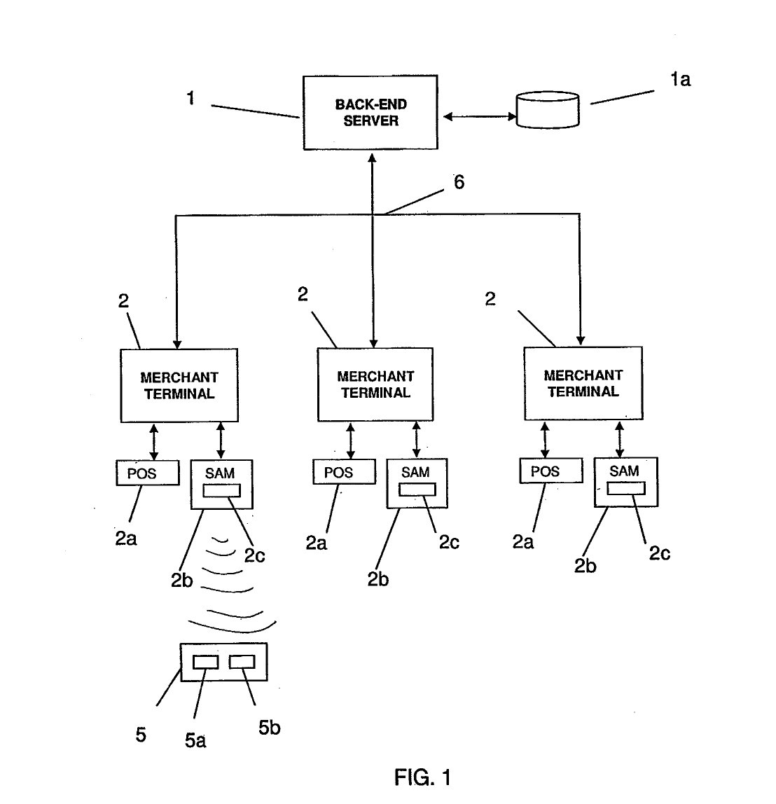

A first embodiment of the present invention will be described herein with reference to FIGS. 1 to 3. The following discussion is intended to provide a brief, general description of a suitable computing environment in which the present invention may be implemented. Although not required, the invention will be described in the general context of computer-executable instructions, such as program modules, being executed by a computer such as a personal computer, laptop computer, notebook computer, tablet computer, PDA and the like. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring firstly to FIG. 1, the first embodiment is implemented using a computerised system having a back-end server (1) which includes a standard desktop PC, and, a plurality of merchant terminals (2) communicably connected to the back-end server (1) via a WAN (6).

Each of the merchant terminals (2) include a POS device (2a) such as an electronic cash register which is able to process cash payments provided by customers to the merchant. The POS device (2a) is interfaced with an external smart card reader (2b) via a USB connection, or alternatively, via an RS232C connection. The smart card reader (2b) includes a contactless interface so that it is able to read/write to contactless customer smart cards (5).

The smart card reader (2b) includes a secure access module (SAM)—that is, it is a dedicated processing device adapted for authenticated interaction with a customer smart card (5). This will involve the use of suitable encryption protocols.

The smart card reader (2b) is programmed to visually output instructions to the customer via an integrated display screen (2c) which conveniently allows the customer to be guided through the steps involved in having his change credited to his electronic purse. This will be discussed by way of example further in the description.

The back-end server (1) is programmed to, amongst other things, store and process both customer and merchant electronic purses during settlement. A mirror of each customer electronic purse is stored on the customer smart cards (5).

The back-end server (1) can be implemented using a standard desktop PC or the like having a database (1a) implemented using any suitable software suite such as may be sold by Oracle Corporation and the like.

The first embodiment method includes the step of the customer having to obtain a customer smart card (5) from either a participating merchant, or, from a vending machine. A cost may be incurred for obtaining the customer smart card (5) and this may conveniently generate an additional revenue stream to be exploited by an administrator of the system. The customer smart card (5) includes, an embedded processor (5a), a memory device (5b), and, a unique identifier stored in the memory device.

Upon purchasing a customer smart card (5), the customer is required to have the customer registered with the back-end server (1). This is effected with the assistance of the merchant who will scan the customer smart card (5) with the smart card reader (2b) whereby the unique identifier embedded in the customer smart card (5) is sent to the back-end server (1) together with personal details submitted manually by the customer. The back-end server (!) will initialise a new customer electronic purse which is stored in to the database (1a) of the back-end server (1).

The merchants will also be required to initialise their own merchant electronic purses and these will also be stored in the database (1a) of the back-end server (1). Merchant electronic purses are identified by reference to a unique identifier embedded in the access device (2b) of the merchant terminal at the merchant premises. The merchants will generally have topped up their electronic purses so that during the course of trade, credit from the merchant's electronic purse is able to be transferred to the appropriate customer electronic purse in substitute for having to physically dispense change to the customer. Customers are able to top up their electronic purses directly with the back-end server (1) using a electronic payment system infrastructure such as GIRO which should be interfaced with the back-end server (1).

It would be appreciated that in alternative embodiments of the present invention, customer smart cards are able to be implemented anonymously—the smart card is not customer-specific. In this regard, when a smart card is issued, there is no need to register the customer's specific details so that a unique association can be created between the customer using the smart card and the customer smart card itself.

Customers are also able to voluntarily credit their electronic purses at any time. For customer's, this may be facilitated by having a “top-up” machine made available wherein the “top-up” machine is also communicatively connected to the back-end sever (1) via the WAN (6). When adding credit to the customer smart card (5), the “top up” machine is adapted to read the unique identifier contained in the customer smart card (5), process a credit card or cash payment from the customer, and then upon verification of payment, instruct the back-end server to credit an amount to the corresponding customer electronic purse with the amount of credit purchased by the customer.

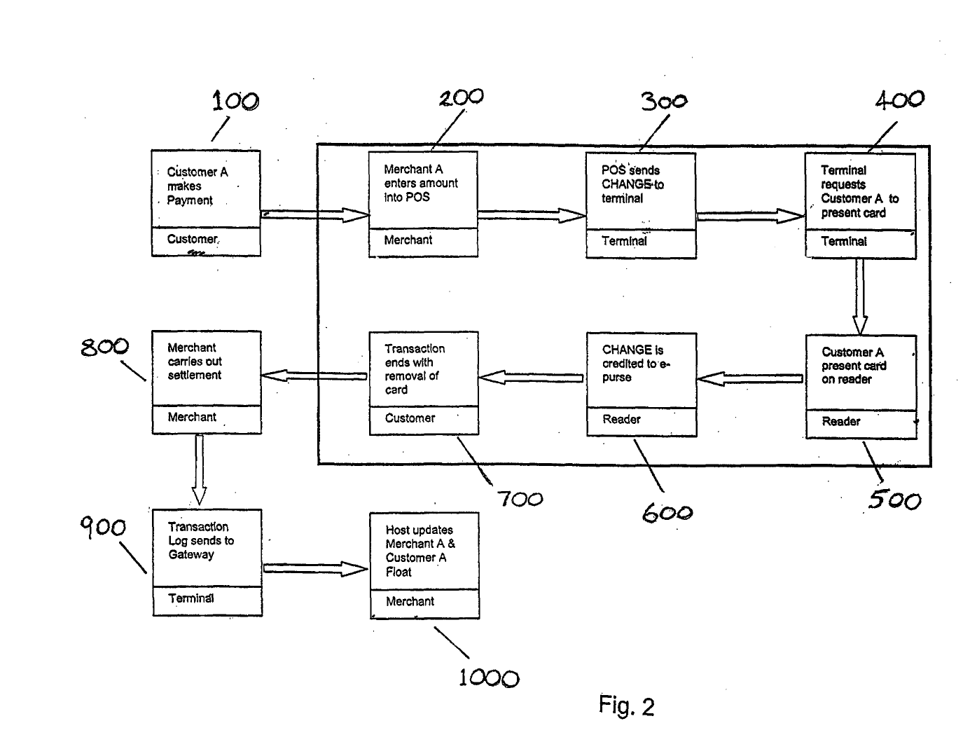

In use, when a purchase transaction is conducted between the customer and the merchant, the transaction is carried out using the POS device (2a) as broadly indicated by block (100)-(300) in FIG. 2. The smart card reader (2b) is programmed to detect when the POS device (2a) is to provide change to the customer in response to the cash payment transaction. The smart card reader (2b) will thereafter prompt the customer, via a text-based instruction presented via the display screen (2c), to place its customer smart card (5) in proximity to the smart card reader (2b) so that it can be read and authenticated. This step is broadly indicated by block (400) in FIG. 2.

As shown at block (600) the smart card reader (2b) then credits the customer electronic purse disposed on the smart card (5) before proceeding to generate a transactional log for the transaction that will be sent to the back-end server (1) so that it can settle the transaction in real-time. The transactional log includes the following information:
(a) the unique identifier of the customer smart card (5);
(b) the unique identifier of the merchant; and
(c) and the amount of change owing to the customer from the merchant.

Once the transactional log has been generated, the smart card reader (2b) will advise the customer, via a text-based instruction presented via the display screen (2c), that it is now safe to remove the customer smart card (5) from proximity with the smart card reader (2b). This is broadly represented by block (700) in FIG. 2.

Thereafter, the merchant terminal (2) initiates settlement of the transaction on the back end server (1) as indicated at block (800) of FIG. 2. This involves transmitting the transactional log to the back-end server (1) via the WAN (6) so that the back-end server (1) is able to effect settlement in real-time by crediting the appropriately identified customer electronic purse by the amount of changed owed, and, by debiting an equivalent amount from the electronic purse of the identified merchant. The steps of sending the transactional log, and, settling the customer and merchant electronic purses in the back-end server (1) are broadly represented by blocks (900) and (1000) in FIG. 2 respectively.

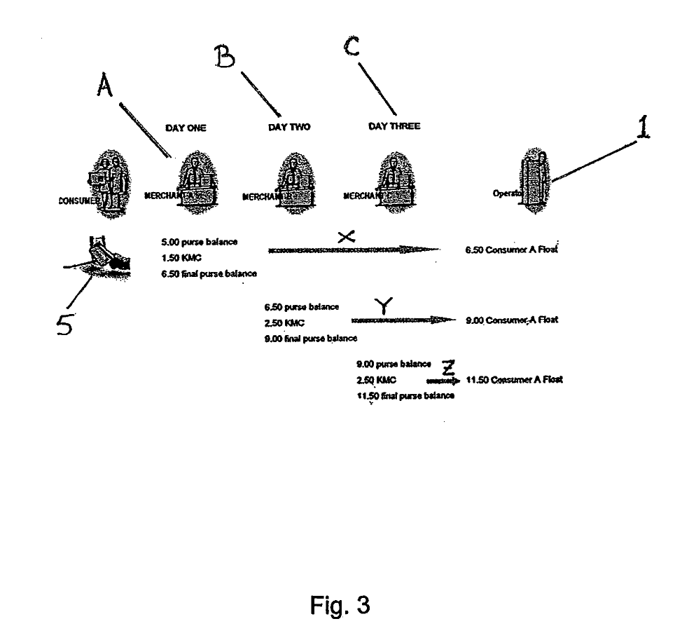

FIG. 3 shows the relative ease with which the balance in the electronic purse of the customer smart card (5) and in the back-end server (1) are able to be reconciled in real-time when a customer makes successive purchases from merchants (A), (B) and (C) over a 3 day period. Arrows (X), (Y) and (Z) represent the real-time transmission of transactional logs to the back-end server (1) wherein the cumulative balance of the customer's electronic purse is updated in both the smart card (5) and the back-end-server (1) are kept consistent due to real-time settlement conducted by each merchant (A), (B) and (C).

In an alternative embodiment of the present invention settlement of certain transactions in the back-end server (1) is able to be effected on a delayed basis. In this regard, due to the possibility of discrepancies arising between the electronic purse balance in the back-end server (1) and the customer smart card (5), the first embodiment provides a counter disposed on the customer smart card (5) which is adapted for tracking unsettled transfers of change between merchants and the customer. Typically, the counter includes a read/writable data file stored in the memory device (5b) of the customer smart card (5). More specifically, the counter includes details of at least the following:
(a) information identifying merchant(s) which have not yet effected settlement;
(b) information detailing the amount of change that has not been settled by the respective merchant(s);
(c) information detailing a cumulative amount of change that may be owed to the customer by merchant(s);
(d) information detailing the balance of the customer's electronic purse.

Where delayed settlement is accommodated, a predetermined threshold condition is set is used as a reference point in determining when an unsettled transaction is to be settled.

For instance, the predetermined threshold condition could be that settlement of unsettled reconciliation of transactions is to be triggered whenever it is detected that a cumulative amount of change owing to the customer from at least one merchant exceeds a certain level (eg. $2.00). Thus, whenever the customer presents his customer smart card (5) at a merchant terminal, the access device is programmed to automatically perform the following steps:
(i) read the customer smart card (5) and detect whether any unsettled transactions are recorded in the counter; and
(ii) effects settlement for any such detected unsettled transactions, if the predetermined threshold condition has been met (eg. if a cumulative amount of change exceeds a predetermined threshold amount of $2.00);
(iii) re-setting the counter of the customer smart card (5) to indicate that unsettled transaction(s) have now been settled, once settled;
(iv) adjusting the mirror electronic purse balance contained on the customer smart card (5) such that the back-end server (1) and customer smart card (5) are consistent.

In yet further embodiments of the present invention, there may not be a back-end server at all. In this alternative embodiment, the customer's electronic purse is stored solely in the smart card itself, and the merchant's electronic purse is stored in the access device of the merchant terminal. In this arrangement, the access device of every merchant terminal includes an SAM in order to allow for secure reading and writing of customer smart card electronic purses.

Thus, when settlement takes place in this arrangement (either in real-time or on a delayed basis), the access device may directly credit the customer electronic purse of the customer smart card, and, may debit the merchant electronic purse stored in the access device.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

1. A method of storing change resulting from a cash purchase between a customer and a merchant, the method comprising: providing the customer with an anonymous customer electronic purse on a portable storage device for storing credit and the merchant with a merchant electronic purse for storing credit purchased by the merchant, reading and/or writing to the portable storage device through an access device adapted for reading and/or writing to the portable storage device, electronically crediting a value representing the change in to the customer electronic purse from the merchant electronic purse, and debiting the merchant's electronic purse to an amount equivalent to an amount of change that is credited to the customer electronic purse, wherein the value of the change that is credited in to the customer electronic purse is able to be redeemed for further purchases, the customer electronic purse is stored solely in the portable storage device and the merchant electronic purse is stored solely in the access device, facilitating immediate transfer of credit directly from the merchant electronic purse to the customer electronic purse via the access device without communicatively connecting to a back-end server.

2. A method as claimed in claim 1, wherein the reading and/or writing to the portable storage device through the access device of a merchant terminal, wherein the merchant terminal further comprises a point-of-sale device.

3. A method as claimed in claim 1, wherein the method is implemented using a computerised system comprising:
a back-end server communicatively connected to a plurality of merchant terminals, wherein the merchant terminals comprises a point-of-sale device and the access device adapted for reading and/or writing to a portable storage device.

4. A method as claimed in claim 1, wherein the portable storage device is a:
(a) a chip-based card (ie a “smart card”);
(b) a stored value card; or
(c) a radio frequency identification (RFID) card.

5. A method as claimed in claim 1, wherein the access device comprises a smart card reader and/or a secure access module (SAM).

6. A method as claimed in claim 1, wherein the access device comprises a unique identifier which is used to recognize the merchant.

7. A method as claimed in claim 1, including the step of providing the customer with a customer smart card comprising a unique identifier disposed thereon to enable the access device to authenticate the smart card.

8. A method as claimed in claim 7, wherein the customer electronic purse is stored in the customer smart card.

9. A method as claimed in claim 3, wherein the back-end server includes a database adapted for storing a copy of the customer electronic purse and of the merchant electronic purse.

10. A method as claimed in claim 1, further comprising providing a means for the merchant to voluntarily add credit to their respective electronic purse for subsequent transfer to the customer electronic purse.

11. A method as claimed in claim 3, wherein, when cash is owing to the customer from the merchant in the course of conducting a cash purchase comprising:
(i) the access device reads and authenticates the customer smart card;
(ii) the electronic purse of the customer disposed on the customer smart card is credited by the merchant;
(ii) a transactional log is generated by the access device, said transactional log comprising details of the amount of change to be credited to the customer electronic purse, the identity of the merchant, and the identity of the customer; and
(iii) transmitting the transactional log to the back-end server whereby the back-end server is able to debit the merchant electronic purse, and credit the customer's electronic purse by reference to the transactional log.

12. A method as claimed in claim 1, wherein the settlement is effected either in real-time or on a delayed basis.

13. A method as claimed in claim 12, comprising storing a counter on the customer smart card, the counter being adapted to record at least one of the following:
(a) information identifying a merchant with which the customer has not settled a transaction;
(b) information identifying an amount of change that has not been settled with the merchant; and/or
(c) information identifying the cumulative amount of change that is owed to the customer by all merchants.

14. A method as claimed in claim 12, wherein when settlement is effected on a delayed basis, settlement is initiated when a predetermined threshold condition is detected, the predetermined threshold condition including:
(a) when a cumulative amount of change owing to the customer exceeds a predetermined threshold level; or
(b) when a predetermined time period has elapsed; and/or
(c) when a predetermined time has arrived.

15. A method as claimed in claim 3, wherein a back-end server is not used, and merchant terminals are adapted to credit an electronic purse disposed on the customer smart card, and, to debit a merchant electronic purse disposed on the access device.

16. A computerised system programmed to perform the method in accordance with claim 1.

17. A computer readable medium for storing a computer program adapted for implementing the method in accordance with claim 1.

18. A system for electronically storing a value equivalent to change resulting from a cash purchase between a customer and a merchant, the system comprising: an anonymous customer electronic purse of a customer comprising a memory stored on a portable storage device for storing credit, the customer electronic purse is stored solely in the portable storage device, a merchant electronic purse of the merchant comprising a memory for storing credit purchased by the merchant, a merchant terminal comprising a point-of-sale device and an access device adapted for reading and/or writing to the portable storage device and electronically crediting a value representing the change into the customer electronic purse from the merchant electronic purse, and debiting the merchant's electronic purse to an amount equivalent to an amount of change that is credited to the customer electronic purse, wherein the value of the change that is credited in to the customer electronic purse is able to be redeemed for further purchases and the merchant electronic purse is stored solely in the access device, facilitating immediate transfer of credit directly from the merchant electronic purse to the customer electronic purse via the access device without communicatively connecting to a back-end server.

19. A system as claimed in claim 18 further comprising:
a back-end server communicatively connected to a plurality of merchant terminals, wherein the merchant terminals each comprise a point-of-sale device and an access device adapted for reading and/or writing to the portable storage device.

20. A system as claimed in claim 18, wherein the portable storage device is a:
(a) a chip-based card (ie a “smart card”);
(b) a stored value card; or
(c) a radio frequency identification (RFID) card.

21. A system as claimed in claim 18, wherein the access device comprises a smart card reader and/or a secure access module (SAM).

22. A system as claimed in claim 18, wherein the access device comprises means for a unique identifier which is used to recognize the merchant.

23. A system as claimed in claim 18, the customer electronic purse is arranged on a customer smart card comprising means for a unique identifier disposed thereon to enable the access device to authenticate the smart card.

24. A system as claimed in claim 18 wherein the customer electronic purse is stored in a customer smart card.

25. A system as claimed in claim 19, wherein the back-end server comprises a database adapted for storing a copy of the customer electronic purse and of the merchant electronic purse.

26. A system as claimed in claim 18, further comprising a means for the customer and/or merchant to voluntarily add credit to their respective electronic purses.

27. A system as claimed in claim 19, wherein the access device transmits a transactional log comprising details of the amount of change to be credited to the customer electronic purse, the identity of the merchant, and the identity of the customer to the back-end server to debit the merchant electronic purse, and credits the customer's electronic purse by reference to the transactional log.

28. A system as claimed in claim 18, wherein the customer electronic purse is on a customer smart card and the smart card comprises a counter being adapted to record at least one of the following:
(a) information identifying a merchant with which the customer has not settled a transaction;
(b) information identifying an amount of change that has not been settled with the merchant; and/or
(c) information identifying the cumulative amount of change that is owed to the customer by all merchants.

29. A system as claimed in claim 18, wherein the access device comprises the merchant electronic purse.
